(19) United States
(12) Patent Application Publication
(10) Pub. No.: US 2004/0160513 A1
(43) Pub. Date: Aug. 19, 2004

(54) Hand held surface to underwater video system

(76) Inventor: David Scott Kilmer, Lakeside, CA (US)

Correspondence Address: DAVID S. KILMER, 12135 SERENA RD, LAKESIDE, CA, 92040, US

(21) Appl. No.: 10/248,757

(22) Filed: Feb. 14, 2003

(51) Int. Cl. H04N 7/18

(52) U.S. Cl. 348/81

(57) ABSTRACT

A Hand Held Surface to Underwater Video System, for use by coaches, instructors and assistants, to record the sub-surface physical actions of participants in aquatic activities from a vantage above surface, comprised of a waterproof video camera mechanically attached to a telescoping pole with a mounting platform adaptable to several commercially available video recording devices with external video signal input capabilities.

### BACKGROUND OF INVENTION

In order to properly look at developing the underwater video system it is important to know the history of the idea behind the project.

Coaches have long realized the incredible value of using visual images in order to better coach their athletes. In swimming, this is often accomplished by watching other swimmers, either in live action or on videotape. In the mid 80's as video cameras became available and affordable to the coaching community many were able to take advantage of these cameras to offer direct visual feedback of technique to each individual swimmer.

However, consumer video cameras are limited to seeing the above water portion of a swimmer's technique. The first product to record underwater became available in the late 80's. This product used a system of mirrors in a periscope type housing to see underwater. The unit (many generations later) is still in production today. Although the product allows a high quality picture, it is cumbersome, requires an external monitor, a fixed position on the pool deck, and is too expensive for most swimming organizations.

In the past 5 years a few companies have arisen that will come to your pool, set up a track system, (which has a waterproof camera on a motorized track underwater) and videotape athletes for a fee. This is extremely cumbersome, and makes videotaping accessible on a very limited basis.

One other product incorporates a cart system with attached pole and underwater camera. While this is an affordable product, and not very difficult to set up, it is still somewhat cumbersome to use.

The goal was to develop an underwater camera for personal coaching use that would be affordable and simple to use. The availability of security cameras to the average consumer was the starting point. One was purchased and enclosed in an airtight PVC housing. It was pool tested. The camera needed a way to be submerged and controlled. A broomstick was the first solution.

During initial testing, the short video connecting cable made it difficult to have a recording device easily viewable. In came the idea of attaching a tripod pan head with a quick release to the pole. This was more portable but too long for convenient storage. This lead to testing different telescoping poles—eventually culminating with a 3-section aluminum pole with an inside diameter sufficient to house the cable from the camera. The basic combination of components that had heretofore never been combined comprising the underwater video system were now in place, a waterproof camera assembly, a telescoping pole, and a tripod type pan mounting head to attach a camcorder. This combination of components created a small, convenient hand-held easily portable underwater viewing system with virtually no set-up required.

### BRIEF DESCRIPTION OF DRAWINGS

FIG. 1 Hand Held Surface to Underwater Video System.

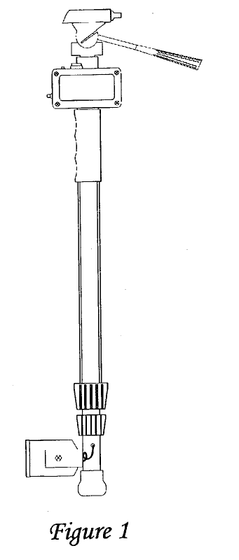

FIG. 2 Waterproof CCD Video Camera Assembly.

FIG. 3 Telescoping Pole Assembly, Compressed.

FIG. 4 Telescoping Pole Assembly, Extended.

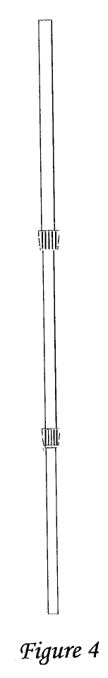

FIG. 5 Junction Box.

FIG. 6 Pan Head Assembly, Rear View.

FIG. 7 Pan Head Assembly, Side View.

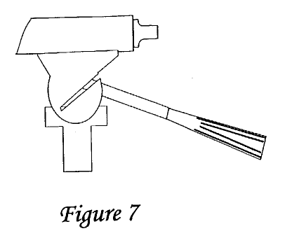

FIG. 8 Electrical Schematic.

### DETAILED DESCRIPTION

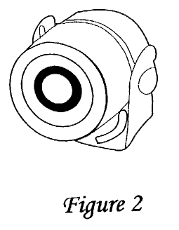

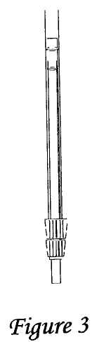

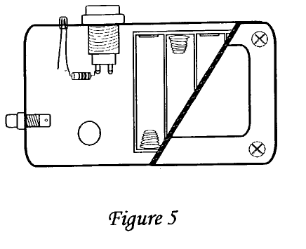

1. The device consists of a c.c.d. (Charge-coupled device) video image generating device, Waterproof Camera Assembly (FIG. 2) hereafter referred to as “camera”. The camera is fixed to a telescoping pole(FIGS. 3 & 4) in such a manner that it may be adjusted manually in the vertical plane. Four electrical leads from the camera are encased in a waterproof coiled cable and allow power to be transmitted to the camera and the video image to be transmitted from the camera to a junction box (FIG. 5).

2. The telescoping pole (FIG. 3) is in three sections and when compressed is approximately 30 inches long. The pole extension is limited to approximately 63″ by built in raised bead stops on the pole sections. The electrical leads from the camera in an expandable coiled cable are located inside of the telescoping pole.

3. The cable is terminated in a junction box affixed to the telescoping pole. (FIG. 5). The junction box holds replaceable batteries to power the camera, an “on-off” switch, a light emitting diode to show on/off condition, an RCA jack for transmitting the signal of the underwater camera to a user supplied video camera. The junction box has a removable panel for easy access to replace batteries.

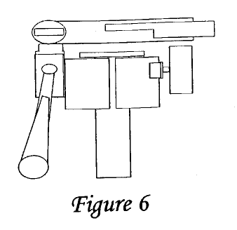

4. Located on the top of the telescoping pole is a video camera pan head assembly with a quick release shoe (FIGS. 6 & 7) to allow the user to attach various models of camcorders to the Hand Held Surface to Underwater Video System. The pan head allows the camera to pan, tilt, and swivel independently of the pole.

1. A hand held assembly for relaying underwater video images of swimmers, divers, and other aquatic athletes to an above water viewing/recording device, comprising: a waterproof video camera assembly (FIG. 2) attached to a telescoping pole (FIGS. 3 & 4) using a mount which allows vertical adjustment of the camera to a desirable photographing angle; electrical connection consisting of a cable of wires from the video camera to a junction box (FIG. 5) mounted near the top of the telescoping pole for power input and video image output.

2. An apparatus of claim 1, which is a 3 section telescoping pole (FIGS. 3 & 4) that provides: a base for connecting the waterproof video camera assembly; an enclosure for the video cable; a base for connecting the junction box; a base for connecting a universal pan head to mount a camcorder (which is not part of the apparatus).

3. An apparatus of claim 1, which is a commercially available video camera mounting platform, commonly called a “pan head” assembly or “tilt pan head assembly” (FIGS. 6 & 7) a means of attaching the “pan head” to the telescoping pole using aluminum rivets.

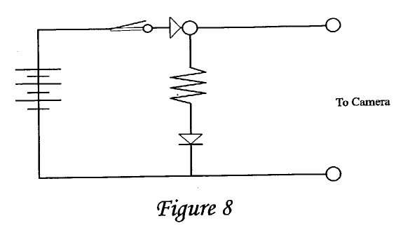

4. An apparatus of claim 1, a junction box (FIG. 5) made of plastic which houses batteries and circuitry to provide power for the underwater video camera assembly and which is attached to the telescoping pole comprising: an “on” and “off” switch; a light emitting diode to show the “on/off” condition; an electrical circuit (FIG. 8) to provide the power from the batteries to the underwater camera; a removable cover to allow changing of the batteries; an RCA jack for output to an external recording device; a means of attaching the apparatus using a plastic “conduit” mounting clamp.
